(19) United States
(12) Patent Application Publication
(10) Pub. No.: US 2016/0054974 A1
(43) Pub. Date: Feb. 25, 2016

(54) Radio Device Capable of Switching Play Message Automatically

(71) Applicants: MiTAC International Corp., Kuei San Township (TW); MiTAC Research (Shanghai) Ltd., Shanghai (CN)

(72) Inventor: Hui Huang, Shanghai (CN)

(73) Assignees: MiTAC International Corp.; MiTAC Research (Shanghai) Ltd.

(21) Appl. No.: 14/598,039

(22) Filed: Jan. 15, 2015

(30) Foreign Application Priority Data
Aug. 22, 2014 (CN) 201410417899.7

(51) Int. Cl. G06F 3/16

(52) U.S. Cl. CPC G06F 3/16

(57) ABSTRACT

A radio device capable of switching play message automatically and a method thereof. The device includes a wireless signal receiving module, a storing module, a speaker module and a processing module. The wireless signal receiving module receives a wireless signal of a broadcasting channel and demodulates an original signal based on the wireless signal. The storing module stores a music file. The speaker module selectively plays a broadcasting message, based on the original signal, or the music file. The processing module calculates a signal strength value based on the original signal, and determines whether the signal strength value is greater than a strength threshold value, if so, the processing module transmits the original signal to the speaker module, such that the speaker module plays the broadcasting message based on the original signal, otherwise, the processing module controls the speaker module to play the music file.

### CROSS-REFERENCE TO RELATED APPLICATION

This application claims the benefit of China Patent Application No. 201410417899.7, filed on Aug. 22, 2014, in the State Intellectual Property Office of the People's Republic of China, the disclosure of which is incorporated herein in its entirety by reference.

### FIELD OF THE INVENTION

The present invention relates to a radio device, and more particularly to a radio device capable of switching play message automatically and a method thereof.

### BACKGROUND OF THE INVENTION

Most of the present motor vehicles generally come with a radio device for converting a high-frequency signal received by an antenna into an audio signal through demodulation and then transmitting the audio signal to a playing device such as an earphone or a speaker. As the radio technology advances, radio waves of different frequencies are transmitted through the air. When so many radio waves are received, the audio signal is situated in a busy area, and many sounds are mixed altogether. As a result, nothing can be heard clearly. To select a desired radio program, the antenna is provided for receiving the high-frequency signal, and then a select circuit (or a radio channel) installed in the radio device selects the desired program and filters unwanted signals to avoid interference between signals. The select circuit can be a button for selecting a channel when we listen to a broadcast program, and the output of the select circuit selects a high-frequency amplitude modulation signal of a radio station. However, it is not workable by just using the high-frequency amplitude modulation signal to push the earphone (or electro-acoustic device) directly, and it is also necessary to resume the high-frequency amplitude modulation signal to its original audio signal, and such reverse process is called demodulation, and the demodulated audio signal is transmitted to the earphone before a broadcasting message can be received.

If the radio device is interfered, the intensity of the demodulated audio signal is not sufficient, the broadcasting message played from a loudspeaker of the radio device is full of noises. In a long time of playing the noises, the mood of the driver and passengers will be affected adversely. In view of this drawback, the inventor of the present invention designed and developed a radio device capable of switching play message automatically as well as its method to overcome the drawback of the prior art and enhance the industrial application of the radio device.

### SUMMARY OF THE INVENTION

In view of the aforementioned drawback of the prior art, it is a primary objective of the present invention to provide a radio device capable of switching play message automatically and a method thereof to overcome the drawback of the convention radio device that keeps playing noises when the received signals are too weak and the broadcasting messages played by the radio device have noises.

To achieve the aforementioned objective, the present invention provides a radio device capable of switching play message automatically. The radio device comprises a wireless signal receiving module, a storing module, a speaker module and a processing module. The wireless signal receiving module is used for receiving a wireless signal of a broadcasting channel and demodulating an original signal based on the wireless signal. The storing module has a music file stored therein. The speaker module selectively plays a broadcasting message based on the original signal or a music file. The processing module calculates a signal strength value based on the original signal and determines whether the signal strength value is greater than a strength threshold value, if so, then the processing module will transmit the original signal to the speaker module, and the speaker module will play the broadcasting message based on the original signal, or else the processing module will control the speaker module to play the music file.

Preferably, the processing module may control the speaker module to switch from playing the broadcasting message to playing the music file immediately, if the processing module determines that the signal strength value is smaller than the strength threshold value.

Preferably, the processing module may control the speaker module to switch from playing the broadcasting message to playing the music file, if the processing module determines that the signal strength value is smaller than the strength threshold value throughout a predetermined time.

Preferably, the radio device capable of switching play message automatically may further comprise a prompt module coupled to the processing module, such that when the processing module determines that the signal strength value is smaller than the strength threshold value, the processing module may control the prompt module to generate a prompt message and then controls the speaker module to play the music file.

Preferably, the radio device capable of switching play message automatically may further comprise a transmitting module for receiving the music file and storing the music file into the storing module.

To achieve the aforementioned objective, the present invention provides a radio broadcasting method of switching play message automatically applicable in a radio device capable of switching play message automatically, and the radio device comprises a wireless signal receiving module, a storing module, a speaker module and a processing module, and the radio broadcasting method comprises the steps of: receiving a wireless signal of a broadcasting channel by the wireless signal receiving module; demodulating an original signal based on the wireless signal by the wireless signal receiving module; and calculating a signal strength value based on the original signal by the processing module, and the processing module determines whether the signal strength value is greater than a strength threshold value, if so, then the processing module will transmit the original signal to the speaker module, such that the speaker module plays the broadcasting message based on the original signal, or else the processing module will control the speaker module to play a music file stored in the storing module.

Preferably, the radio broadcasting method capable of switching play message automatically may further comprise the step of controlling the speaker module to switch playing the broadcasting message to playing the music file by the processing module, if the processing module determines that the signal strength value is smaller than the strength threshold value.

Preferably, the radio broadcasting method capable of switching play message automatically may further comprise the step of controlling the speaker module to switch playing the broadcasting message to playing the music file by the processing module, if the processing module determines that the signal strength value is smaller than the strength threshold value throughout a predetermined time.

Preferably, the radio broadcasting method capable of switching play message automatically may further comprise the step of controlling the prompt module to generate a prompt message and then controls the speaker module to play the music file by the processing module, if the processing module determines that the signal strength value is smaller than the strength threshold value.

Preferably, the radio broadcasting method capable of switching play message automatically may further comprise the step of receiving the music file and storing the music file into the storing module by the transmitting module.

In summation, the radio device capable of switching play message automatically and a method thereof in accordance with the present invention can use a central processing unit to detect the intensity of a signal received by the antenna, such that if the radio device is interfered and the antenna fails to receive the signal or the intensity of the received signal is too week, then the central processing unit will switch the loudspeaker from playing the broadcasting message to playing the music file, so as to avoid the problem of keeping playing noises when the intensity of the signal of the radio device is too weak or cannot be received.

### BRIEF DESCRIPTION OF THE DRAWINGS

FIG. 1 is a block diagram of a radio device capable of switching play message automatically in accordance with a first preferred embodiment of the present invention;

FIG. 2 is a block diagram of a radio device capable of switching play message automatically in accordance with a second preferred embodiment of the present invention; and

FIG. 3 is a flow chart of a radio broadcasting method capable of switching play message automatically in accordance with the present invention.

### DESCRIPTION OF THE PREFERRED EMBODIMENTS

The technical characteristics, contents, advantages and effects of the present invention will be apparent with the detailed description of a preferred embodiment accompanied with related drawings as follows. It is noteworthy that same numerals are used for representing respective same elements in the drawings.

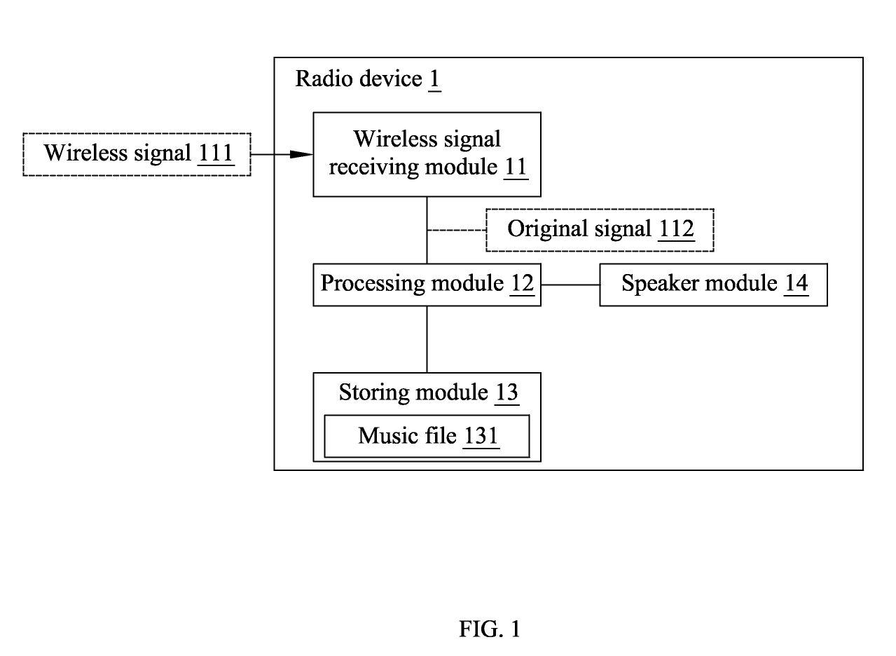

With reference to FIG. 1 for a block diagram of a radio device capable of switching play message automatically in accordance with the first preferred embodiment of the present invention, the radio device 1 comprises a wireless signal receiving module 11, a processing module 12, a storing module 13 and a speaker module 14.

The wireless signal receiving module 11 can be an antenna; the processing module 12 can be a central processing unit (CPU) or a micro-processing unit; the storing module 13 can be a readable information storage medium such as a floppy disk, a hard disk, a CD, a DVD, a magnetic tape or a memory; and the speaker module 14 can be a speaker. The aforementioned components are used as examples for the purpose of illustrating the present invention, but not intended for limiting the scope of the invention.

In this preferred embodiment, a user can turn on a switch of the radio device 1 when driving a car. Now, the wireless signal receiving module 11 receives a wireless signal 111 of a broadcasting channel selected by the user. In addition, the wireless signal receiving module 11 further demodulates an original signal 112 based on the wireless signal 111, wherein the demodulation is a reverse process of a modulation. A different modulation leads to a different demodulation. In correspondence with the types of modulation, the demodulation can be divided into sine wave demodulation (also known as continuous wave demodulation) and pulse wave demodulation. The sine wave demodulation can be further subdivided into amplitude demodulation, frequency demodulation and phase demodulation. In addition, there are hybrids such as single sideband signal demodulation and vestigial sideband signal demodulation. Similarly, the pulse wave demodulation can be divided into pulse amplitude demodulation, pulse phase demodulation, pulse width demodulation and pulse code demodulation. A multiple modulation requires a multiple demodulation.

Further, after the wireless signal receiving module 11 demodulates the original signal 112, the processing module 12 calculates a signal strength value based on the original signal 112 and controls the speaker module to play a broadcasting message based on the signal strength value or a music file 131. Wherein, the processing module 12 will control the speaker module 14 to play the broadcasting message based on the original signal 112, if the signal strength value is greater than a strength threshold value; and the processing module 12 will control the speaker module 14 to play the music file 131 stored in the storing module 13, if the signal strength value is smaller than the strength threshold value.

It is noteworthy to point out that if a user listens to a broadcast at a certain fixed channel and drives a car through a tunnel, an underpass or a cave, the intensity of the signal received by the wireless signal receiving module 11 will be insufficient, or the signal intensity is smaller than the strength threshold value, then the processing module 12 will immediately control the speaker module 14 to switch from playing the broadcasting message to playing the music file 131. Alternately, the processing module 12 can start controlling the speaker module 14 to switch from playing the broadcasting message to playing the music file 131, if the signal strength value is smaller than a strength threshold value throughout a predetermined time. Wherein, the predetermined time can be 3 seconds, 5 seconds, or user defined.

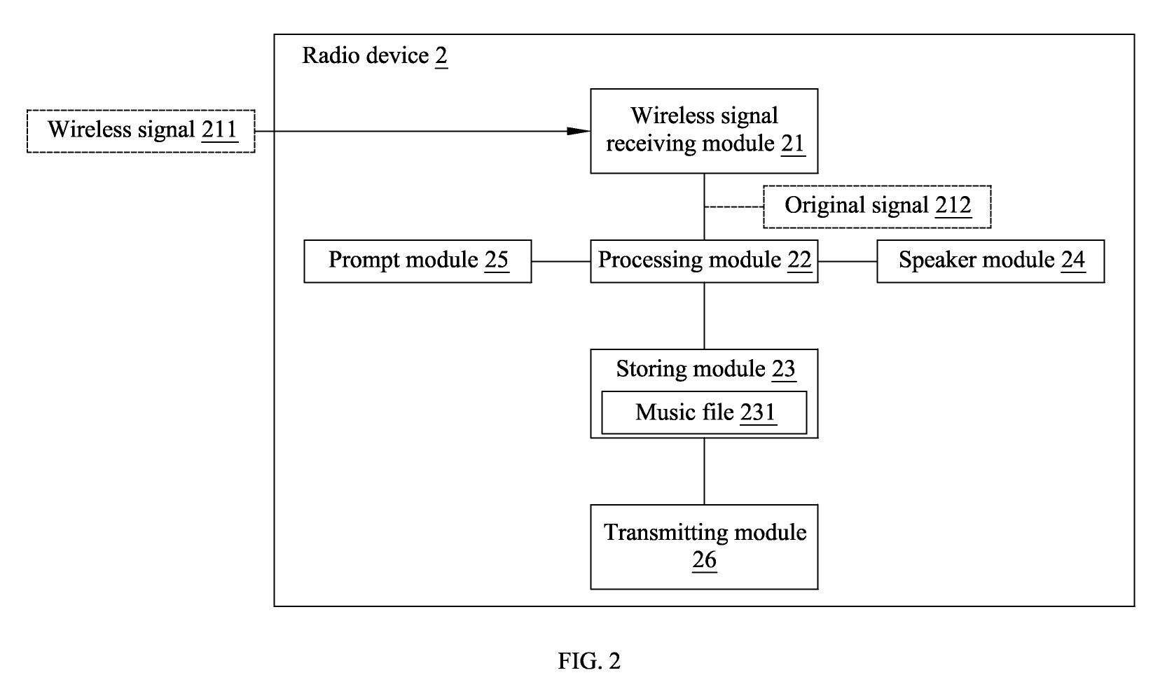

With reference to FIG. 2 for a block diagram of a radio device capable of switching play message automatically in accordance with the second preferred embodiment of the present invention, the radio device 2 comprises a wireless signal receiving module 21, a processing module 22, a storing module 23, a speaker module 24, a prompt module 25 and a transmitting module 26. Wherein, the wireless signal receiving module 21 can be an antenna; the processing module 22 can be a central processing unit (CPU) or a micro-processing unit; the storing module 23 can be an information storage medium such as a floppy disk, a hard disk, an optical disk, a CD, a DVD, a magnetic tape or a memory; the speaker module 24 can be a loudspeaker; and the prompt module 25 can be an LED lamp or a beeper capable of producing a warning sound, but the invention is not limited to aforementioned components only.

Unlike the first preferred embodiment, the processing module 22 of the second preferred embodiment will control the prompt module 25 to blink or generate a prompt sound to prompt a user's speaker module 24 so as to switch from playing a broadcasting message to playing a music file 231 immediately, and then will further control the speaker module 24 to play the music file 231, if the processing module 22 determines that the signal of received by the wireless signal receiving module 21 has a signal strength value smaller than a strength threshold value.

It is noteworthy to mention that the transmitting module 26 can transmit data through an automobile network such as a controller area network bus (CAN Bus), a local interconnect network bus (LIN Bus), a FlexRay, a MOST, a 1394, or an optical fiber network. Wherein, the CAN Bus and the LIN Bus have the advantages of high immediacy, good portability and high extensibility. Of course, the RS232 communication protocol or any other communication protocol can be used to achieve the same data transmission effect. In addition, the transmitting module 26 can be any storage interface port such as a USB port, a SD card port or a MiniSD card port provided for users to transmit and store a video file such as a MP3, MP4 or WMV file into the storing module 23. The aforementioned data accessing method of the transmitting module 26 or the aforementioned prompting method of the prompt module 25 are provided for the purpose of illustrating the present invention, but not intended for limiting the scope of the invention. In addition, the transmitting module 26 can be a Bluetooth device, so that an electronic device with a Bluetooth receiver can be used together with an electronic device such as a tablet PC, a Smartphone, a personal digital assistant (PDA).

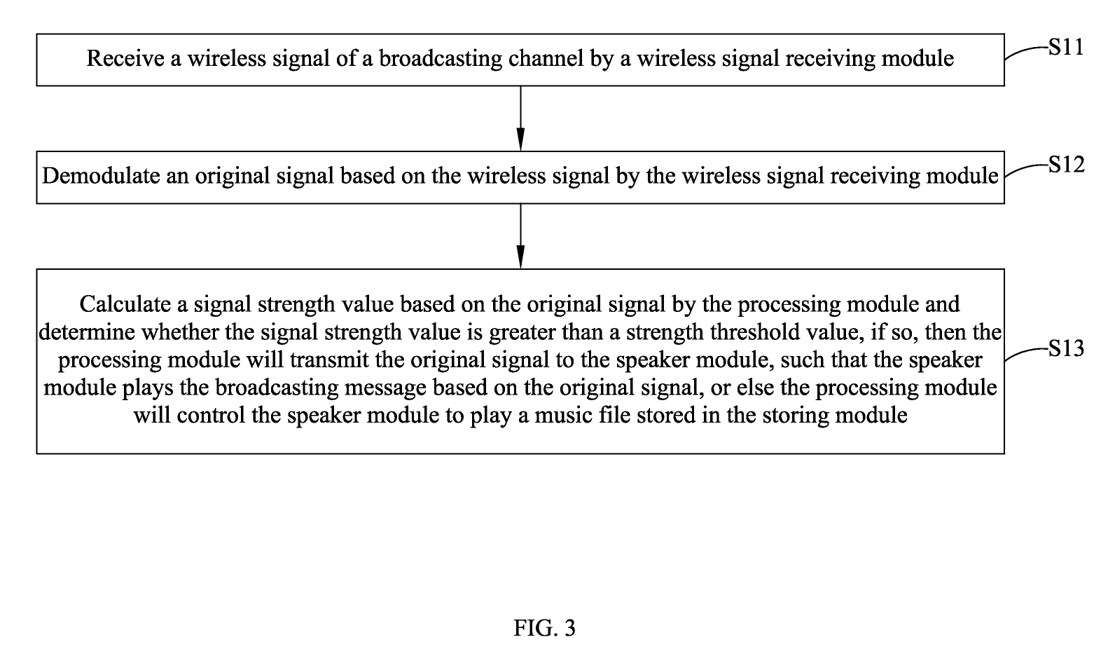

With reference to FIG. 3 for the flow chart of the radio broadcasting method capable of switching play message automatically, the method comprises the following steps:

S11: Receive a wireless signal of a broadcasting channel by a wireless signal receiving module.

S12: Demodulate an original signal based on the wireless signal by the wireless signal receiving module.

S13: Calculate a signal strength value based on the original signal by the processing module and determine whether the signal strength value is greater than a strength threshold value, if so, then the processing module will transmit the original signal to the speaker module, such that the speaker module plays the broadcasting message based on the original signal, or else the processing module will control the speaker module to play a music file stored in the storing module.

The details and implementation of the radio broadcasting method capable of switching play message automatically in accordance with the present invention have been illustrated in the aforementioned block diagram and embodiments of the radio device capable of switching play message automatically, and thus will not be repeated.

In summation of the description above, the radio device and method capable of switching play message automatically in accordance with the present invention can use the processing module to detect the intensity of the original signal which is demodulated from the wireless signal received by the wireless signal receiving module. If the radio device is interfered and the wireless signal receiving module cannot receive any signal or the intensity of the received signal is too weak, then the processing module will control the speaker module to switch from playing the broadcasting message to playing the music file, so as to avoid the problem of continuing playing noises when the radio device has a too-weak signal intensity or fails to receive the signal.

The present invention provides a feasible lamp and complies with the patent application requirements, and thus is duly filed for patent application. While the invention has been described by means of specific embodiments, numerous modifications and variations could be made thereto by those skilled in the art without departing from the scope and spirit of the invention set forth in the claims.

What is claimed is:

1. A radio device capable of switching play message automatically, comprising:
a wireless signal receiving module receiving a wireless signal of a broadcasting channel, and demodulating an original signal based on the wireless signal;
a storing module having a music file stored therein;
a speaker module selectively playing a broadcasting message based on the original signal or playing the music file; and
a processing module calculating a signal strength value based on the original signal, and determining whether the signal strength value is greater than a strength threshold value, if so, the processing module transmits the original signal to the speaker module, and the speaker module plays the broadcasting message based on the original signal, or else the processing module controls the speaker module to play the music file.

2. The radio device capable of switching play message automatically according to claim 1, wherein the processing module controls the speaker module to switch from playing the broadcasting message to playing the music file immediately, if the processing module determines that the signal strength value is smaller than the strength threshold value.

3. The radio device capable of switching play message automatically according to claim 1, wherein the processing module controls the speaker module to switch from playing the broadcasting message to playing the music file, if the processing module determines that the signal strength value is smaller than the strength threshold value throughout a predetermined time.

4. The radio device capable of switching play message automatically according to claim 3, further comprising a prompt module coupled to the processing module, such that when the processing module determines that the signal strength value is smaller than the strength threshold value, the processing module controls the prompt module to generate a prompt message and then controls the speaker module to play the music file.

5. The radio device capable of switching play message automatically according to claim 1, further comprising a transmitting module receiving the music file and storing the music file into the storing module.

6. A radio broadcasting method capable of switching play message automatically, applicable to a radio device capable of switching play message automatically, and the radio device comprising a wireless signal receiving module, a storing module, a speaker module and a processing module, and the radio broadcasting method comprising the following steps of:
receiving a wireless signal of a broadcasting channel by the wireless signal receiving module;
demodulating an original signal based on the wireless signal by the wireless signal receiving module; and
calculating a signal strength value based on the original signal by the processing module, and the processing module determining whether the signal strength value is greater than a strength threshold value, if so, the processing module transmits the original signal to the speaker module, such that the speaker module plays a broadcasting message based on the original signal, or else the processing module controls the speaker module to play a music file stored in the storing module.

7. The radio broadcasting method capable of switching play message automatically according to claim 6, further comprising the step of controlling the speaker module to switch from playing the broadcasting message to playing the music file by the processing module immediately, if the processing module determines that the signal strength value is smaller than the strength threshold value.

8. The radio broadcasting method capable of switching play message automatically according to claim 6, further comprising the step of controlling the speaker module to switch playing the broadcasting message to playing the music file by the processing module, if the processing module determines that the signal strength value is smaller than the strength threshold value throughout a predetermined time.

9. The radio broadcasting method capable of switching play message automatically according to claim 8, wherein the radio device further comprises a prompt module, and the radio broadcasting method further comprises the step of controlling the prompt module to generate a prompt message and controlling the speaker module to play the music file by the processing module, if the processing module determines that the signal strength value is smaller than the strength threshold value.

10. The radio broadcasting method capable of switching play message automatically according to claim 6, wherein the radio device further comprises a transmitting module, and the radio broadcasting method further comprises the step of using the transmitting module to receive the music file and storing the music file into the storing module.
